(19) United States
(12) Patent Application Publication
(10) Pub. No.: US 2026/0132762 A1
(43) Pub. Date: May 14, 2026

(54) Fuel pump assembly

(71) Applicant: Ningbo Xianglong Automotive Components Co., Ltd., Cixi City (CN)

(72) Inventors: Zhuce GE, Cixi City (CN); Bo SHEN, Cixi City (CN); Ruijin ZHANG, Cixi City (CN); Feiyang XIONG, Cixi City (CN)

(73) Assignee: Ningbo Xianglong Automotive Components Co., Ltd., Cixi City, ZJ (CN)

(21) Appl. No.: 19/445,385

(22) Filed: Jan. 9, 2026

(30) Foreign Application Priority Data
Jan. 10, 2025 (CN) 202510042570.5

(51) Int. Cl. F02M 37/00; F02M 37/34; F02M 59/20

(52) U.S. Cl. CPC F02M 37/0017; F02M 37/0047; F02M 37/34; F02M 59/205

(57) ABSTRACT

The present disclosure discloses a fuel pump assembly, including a flange, a pressure regulator, an ejector pump assembly, a pump core, a coarse filter, a fuel reservoir, a level sensor, several corrugated hoses, and suction pipes. The pump core has two outlet conduits, one connected to the flange, and the other connected to the ejector pump assembly. The pressure regulator is installed in the flange; when the pressure in the fuel passage is too high, the fuel flows into the fuel reservoir through the pressure regulator. The ejector pump assembly has at least two suction pipes. The ends of the at least two suction pipes are respectively located at the bottoms of the front and rear ends of the fuel tank. This arrangement can significantly improve the stability of fuel supply when driving on long slopes, thus increasing the vehicle's driving range.

### TECHNICAL FIELD

The present disclosure relates to the field of fuel supply systems, and in particular to fuel pump assembly technology for sled motorcycles, with the aim of improving fuel supply stability and system reliability under complex operating conditions.

### BACKGROUND

In an internal combustion engine system, the primary function of the fuel pump assembly is to deliver fuel from the fuel tank to the engine; its design and performance directly affect the stability of vehicle operation. In existing technology, traditional sled motorcycle fuel pumps typically employ a single-suction pipe structure. During vehicle operation, especially under prolonged slope conditions, the fuel level in the tank is prone to shifting, and the single suction pipe may fail to effectively draw fuel, leading to fuel supply interruption. This phenomenon not only affects the normal operation of the engine but may also cause a decrease in power or stalling, reducing the reliability and endurance of the vehicle.

To overcome the above problems, the present disclosure proposes an improved fuel pump assembly that, through coordinated operation of a multi-suction pipe structure and an ejector pump assembly, effectively enhances the continuity and stability of fuel supply, meeting the usage requirements of sled motorcycles in complex terrains and extreme environments.

### SUMMARY

The present disclosure aims to provide a multi-suction pipe fuel pump assembly, which is particularly suitable for sled motorcycles/snowmobiles to cope with complex conditions such as continuous uphill and downhill slopes during operation. It ensures that the fuel pump assembly can always stably draw fuel from the fuel tank, thereby effectively preventing engine stalling or power interruption caused by unstable fuel supply, and improving the reliability and safety of vehicle operation in complex terrain.

This application provides a fuel pump assembly, comprising a flange, a pressure regulator, an ejector pump assembly, a pump core, a coarse filter, a fuel reservoir, a level sensor, several corrugated hoses, and suction pipes, wherein the pump core, the ejector pump assembly, and the flange sequentially form a fuel passage from the pump core to the flange; the pump core has two outlet conduits, one of which is connected to the flange via the corrugated hose to deliver fuel to an engine, and the other of which is connected to the ejector pump assembly via the corrugated hose to deliver fuel from a fuel tank to the fuel reservoir; the pressure regulator is provided in the flange, and when the pressure in the fuel passage is too high, the fuel flows into the fuel reservoir through the pressure regulator; the ejector pump assembly has at least two suction pipes, one at the front and one at the rear, with a coarse filter pipe at the end of each suction pipe; the ends of the suction pipes are respectively located at the bottoms of the front and rear ends of the fuel tank.

According to some embodiments of the present disclosure, it further comprises the ejector pump assembly connected to the pump core via the corrugated hose; the ejector pump assembly has at least two fuel inlets and at least two fuel outlets, the fuel outlets being located within the fuel reservoir; at least two suction pipes are installed on a fuel suction port.

According to some embodiments of the present disclosure, the two suction pipes are arranged in a front-to-back direction, with their ends contacting the bottoms of the front and rear ends of the fuel tank; the front suction pipe is shorter than the rear suction pipe.

According to some embodiments of the present disclosure, the rear suction pipe is a formed pipe, the end of which is designed to be bent downwards.

According to some embodiments of the present disclosure, the front and rear fuel suction pipes are each provided with a coarse filter pipe at their ends.

According to some embodiments of the present disclosure, the ejector pump assembly is connected to the flange via a torsion spring.

According to some embodiments of the present disclosure, the front suction pipe abuts against the bottom of the front end of the fuel tank and the rear suction pipe abuts against the bottom of the rear end of the fuel tank, thereby ensuring that when the fuel level in the fuel tank shifts, at least one of the ends of the front suction pipe or the rear suction pipe of the fuel pump assembly is always below the fuel level, thus ensuring a continuous fuel supply.

According to some embodiments of the present disclosure, a nozzle element in the ejector pump assembly has a diameter of 0.3 mm to 1.0 mm and is made of brass to adapt to different fuel viscosities and operating environments.

According to some embodiments of the present disclosure, the coarse filter pipe at the end of the suction pipe adopts a mesh structure design, which can not only effectively block impurities from entering the fuel pump assembly, but also continue to draw fuel from the fuel tank when the fuel level is lower than a center line of the suction pipe, thereby significantly improving fuel utilization efficiency.

The present disclosure has the following main advantages:
The multi-suction pipe structure used in the above-mentioned fuel pump assembly has significant advantages: the multi-suction pipe, through its connection with the ejector pump assembly, enhances the fuel inflow, more efficiently meets the fuel demand of the engine under high load and high speed, significantly improves the fuel supply stability of the fuel pump assembly under uphill and downhill driving conditions, optimizes the overall vehicle driving performance, and effectively extends the vehicle's driving range.

This multi-suction fuel pump assembly is adapted to complex fuel tank structures, improves fuel supply reliability, effectively alleviates fuel supply instability caused by fuel level fluctuations, and ensures stable engine operation.

By optimizing the number and locations of fuel suction pipes, the multi-suction fuel pump assembly significantly improves fuel supply stability under extreme driving conditions, enhancing vehicle reliability and driving safety. Furthermore, this design offers significant advantages in fuel flow optimization and system simplification, making it particularly favored in high-performance internal combustion engine systems such as those found in sled motorcycles/snowmobiles.

### BRIEF DESCRIPTION OF THE DRAWINGS

FIG. 1 is an exploded view of the fuel pump assembly of the present disclosure;

FIG. 2 is a schematic view of the fuel pump assembly of the present disclosure in a fuel tank;

FIG. 3 is a schematic view of the fuel pump assembly of the present disclosure;

FIG. 4 is a schematic view of the fuel pump assembly of the present disclosure in a first state in a sled motorcycle being in motion;

FIG. 5 is a schematic view of the fuel pump assembly of the present disclosure in a second state in a sled motorcycle being in motion;

FIG. 6 is a schematic view of the fuel pump assembly of the present disclosure in a third state in a sled motorcycle being in motion;

FIG. 7 is a schematic view of the fuel level under different driving conditions when there is a small amount of fuel in the fuel tank of the present disclosure;

FIG. 8 is a schematic view of the internal fuel flow path of the fuel pump assembly of the present disclosure;

FIGS. 9-13 are structural views of the ejector pump assembly in the fuel pump assembly of the present disclosure, in which FIG. 10 is a top structural view of the ejector pump, FIG. 11 is a structural view of three-way connector/T-fitting, FIG. 12 is a structural view of nozzle; FIG. 13 is a structural view of upper cover;

FIGS. 14-15 are schematic views showing the connection between the ejector pump assembly and the front and rear suction pipes in the fuel pump assembly of the present disclosure.

FIG. 16 is a structural view of the coarse filter at the end of the suction pipe of the fuel pump assembly of the present disclosure.

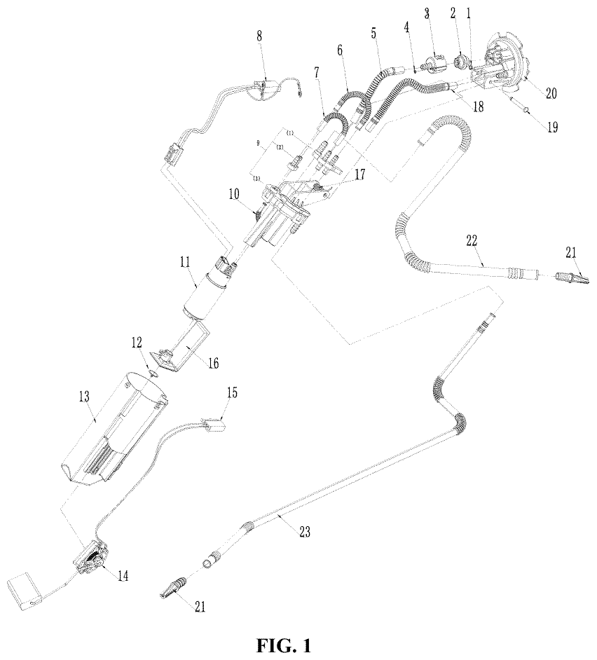

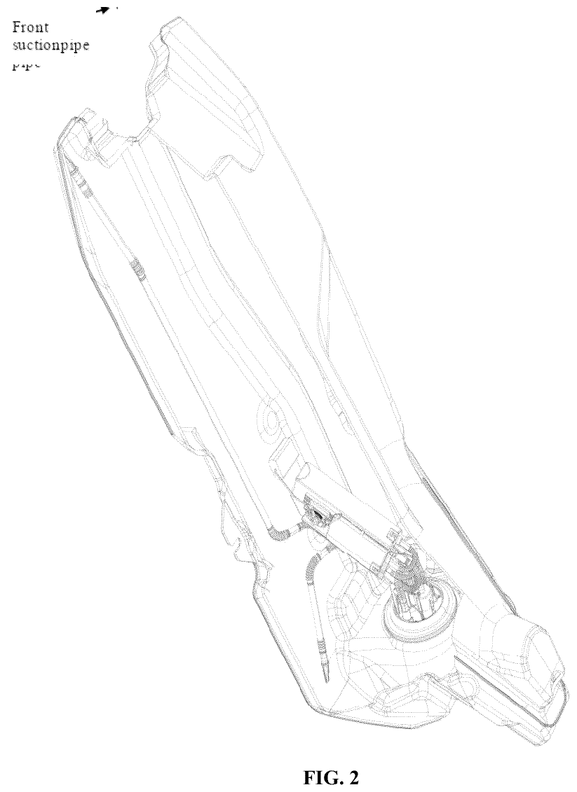

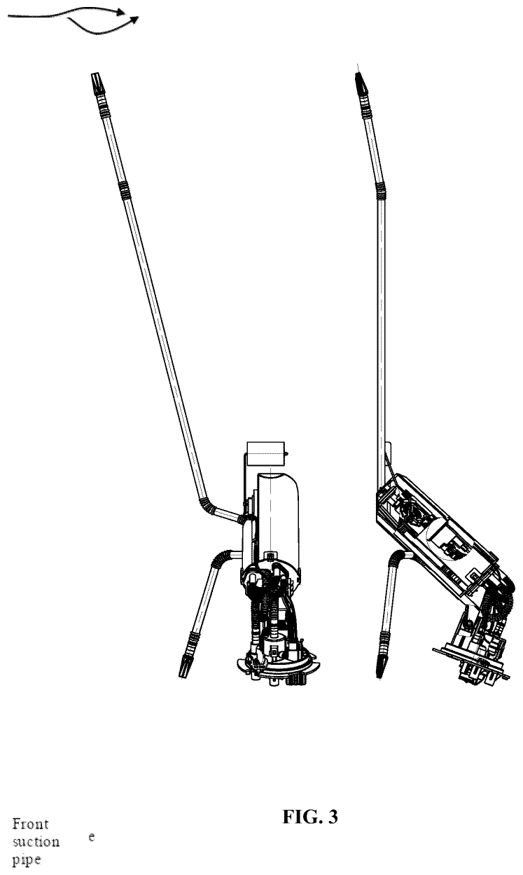

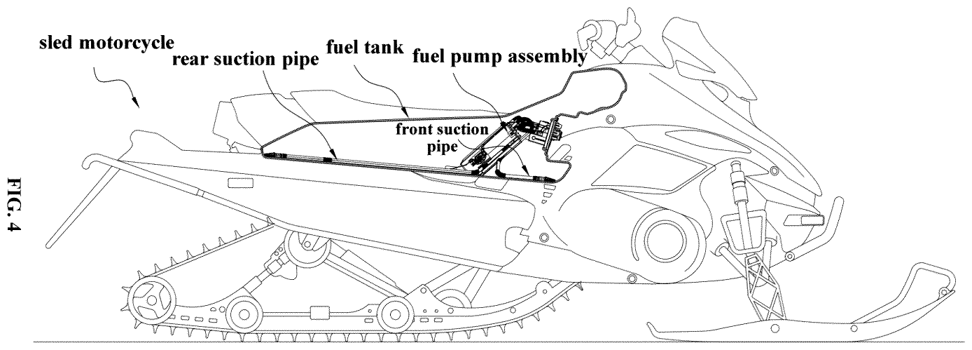

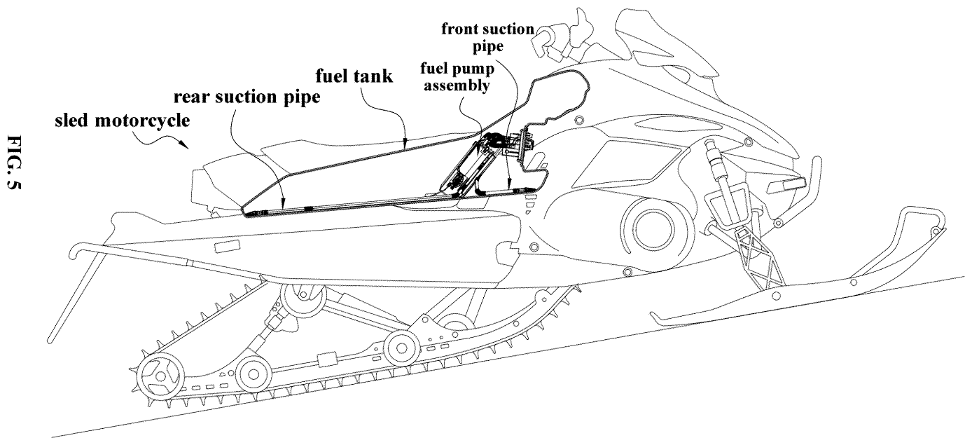

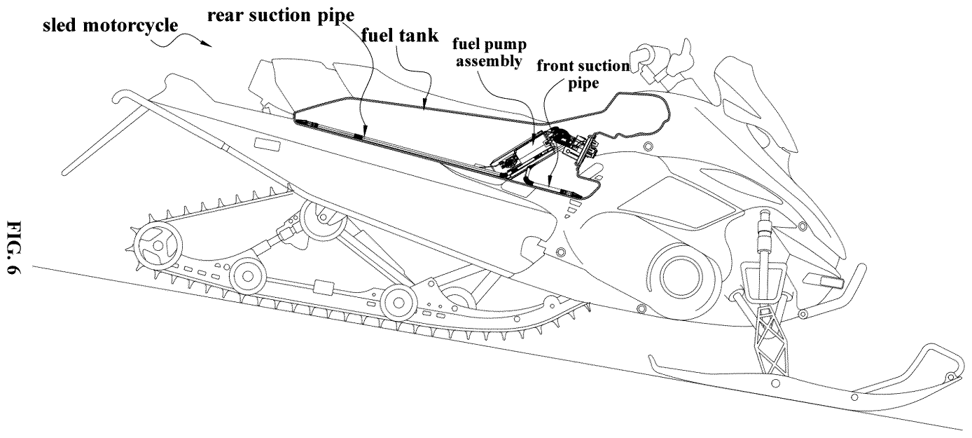

The following are the names of the fuel pump assembly parts corresponding to the numbers in FIG. 1:1—Retaining ring, 2—Pressure regulator, 3—Pressure valve cover, 4—Clip ring, 5—Corrugated hose, 6—Corrugated hose, 7—Corrugated hose, 8—Power cord, 9—Ejector pump assembly, (1)—Top cover, (2)—Nozzle, (3)—Three-way connector/T-fitting, 10—Corrugated hose, 11—Fuel pump, 12—Umbrella valve, 13—Fuel reservoir, 14—Fuel level assembly, 15—Resistor cord, 16—Coarse filter, 17—Torsion spring, 18—Corrugated hose, 19—Pin, 20—Flange, 21—Coarse filter pipe, 22—Suction pipe, 23—Suction pipe.

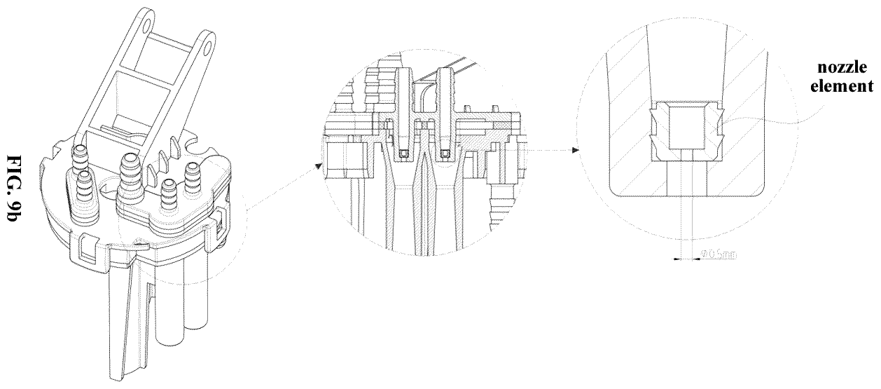

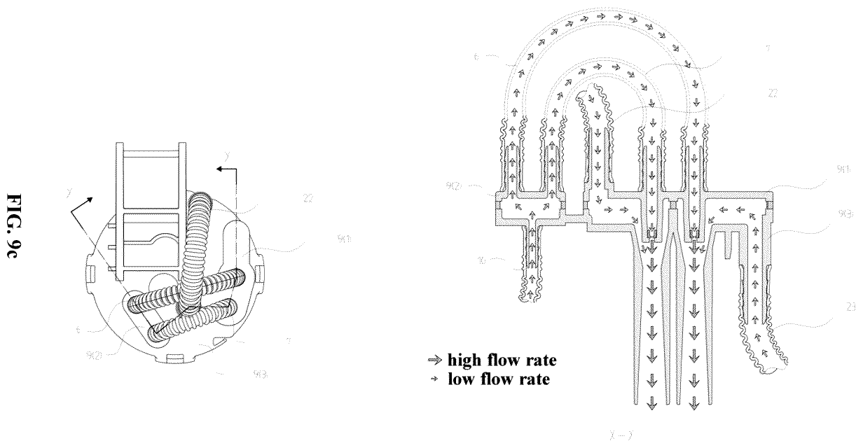

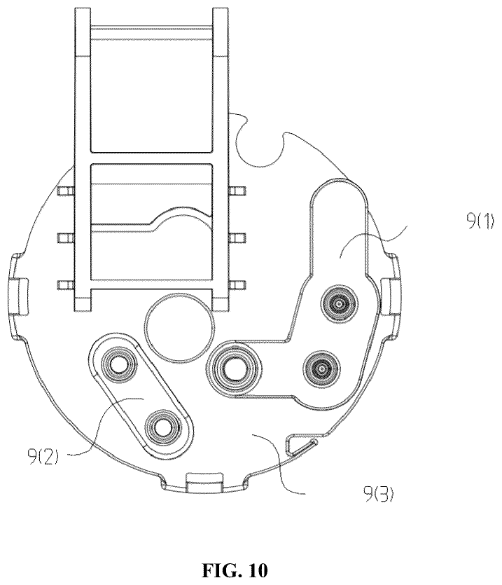

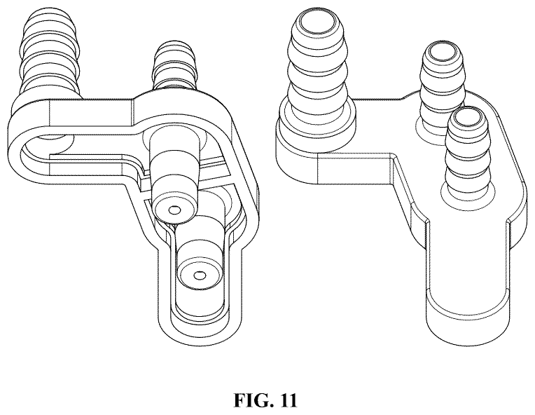

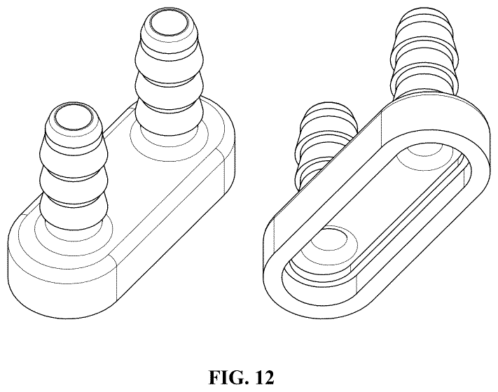

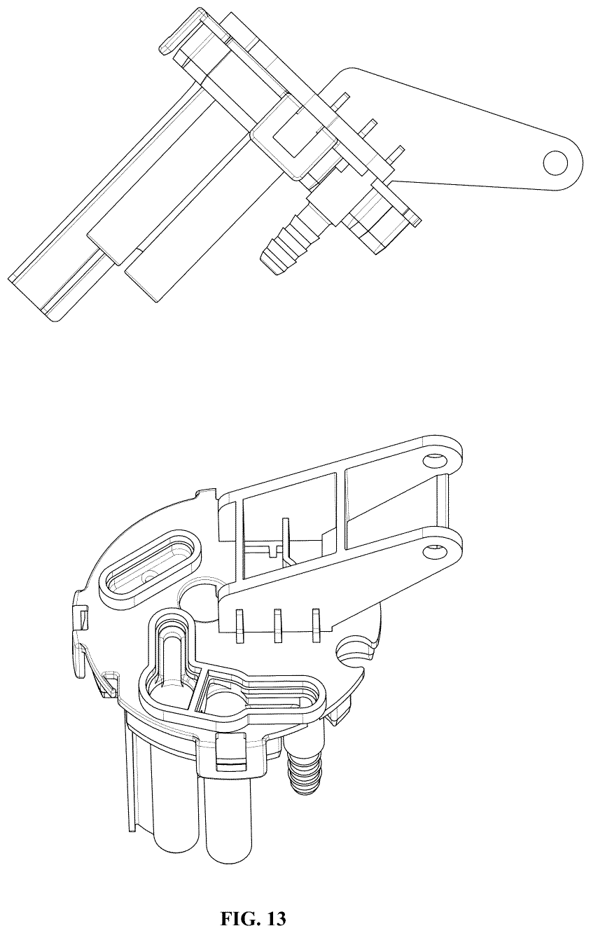

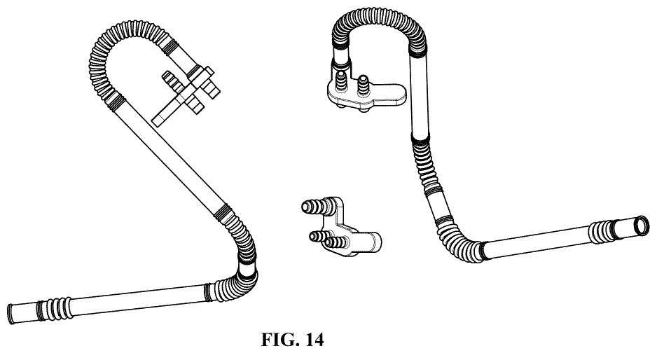

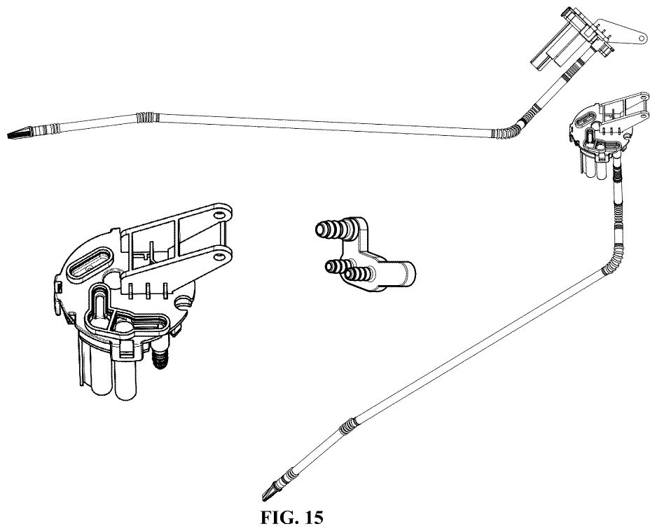

FIG. 9a is an exploded view and actual assembly view of the ejector pump assembly, showing the welded connection structure of the nozzle, three-way connector, and top cover, as well as the corrugated hose 6, corrugated hose 7, suction pipe 22, and suction pipe 23 in the actual installation state of the ejector pump. FIG. 9b is a cross-sectional schematic view of the nozzle inside the three-way connector, showing the flow-dividing design of the 0.5 mm nozzle. FIG. 9c is a schematic view of the negative pressure area of the area in which the three-way connector and the suction pipe are connected, illustrating the principle that after fuel is injected at high speed through two small-diameter nozzles, the increased flow velocity leads to a decrease in local pressure, and marking the location of the negative pressure area and the process of the ejection effect, thus showing how the suction pipe carries the fuel into the fuel reservoir. The function and structure of the ejector pump assembly described in FIG. 9 are as follows:
the ejector pump assembly is an important component of the fuel pump assembly of the present disclosure, its core function is to achieve fuel ejection, diversion, and pressure boosting through the synergistic action of the nozzle, three-way connector, and top cover, ensuring the stability of fuel supply. Even when the fuel level in the tank deviates or fuel demand changes drastically, the ejector pump assembly can maintain a continuous fuel supply, avoiding fuel supply interruption. The specific function and structure are as follows:

Nozzle: The nozzle and top cover are welded together by a hot plate to form an integral structure, it is responsible for fuel diversion and ensures that fuel can be delivered to the target component quickly and efficiently.

Three-way connector: The three-way connector is also welded to the top cover via a hot plate and is used to connect/combine the fuel lines. Through two 0.5 mm diameter nozzles, the high-speed injected fuel creates a regional negative pressure inside the three-way connector (according to Bernoulli's principle, high-speed fuel flow causes a local pressure reduction). This negative pressure, through the ejector effect (‘ejector effect’: refers to the negative pressure phenomenon caused by the local pressure reduction when fuel is injected at high speed through a small diameter nozzle; this effect can guide fuel from the fuel tank into the fuel reservoir through the suction pipe, a process involving a siphon effect), ensures the continuity and stability of fuel supply.

Top cover: The top cover not only provides a carrier for the nozzle and three-way connector, but also enhances the overall structural stability of the assembly, providing reliable support for the operation of the fuel pump under complex working conditions.

To meet the needs of different vehicles or equipment, the ejector pump assembly is designed with the following adjustability:

Size: The overall size of the assembly can be flexibly adjusted according to the fuel tank capacity and fuel line length to ensure optimal fit and performance.

Materials: Nozzle and three-way connector can be made of high-strength, corrosion-resistant materials to adapt to high-temperature, high-pressure or special fuel environments.

Internal structure: The nozzle diameter or the flow splitting angle of the three-way connector can be optimized according to actual needs to improve fuel flow efficiency and adaptability.

By optimizing the function and structure of the ejector pump assembly and combining it with the ability to flexibly adjust its size, materials and structural parameters, the present disclosure can be widely applied to different types of vehicles and fuel supply systems, providing strong technical support for fuel stability under complex operating conditions.

### DETAILED DESCRIPTION OF EMBODIMENTS

The technical solutions of the embodiments of the present disclosure will be clearly and completely described below with reference to the accompanying drawings. The embodiments described below with reference to the accompanying drawings are exemplary and are only used to explain the present disclosure, and should not be construed as limiting the present disclosure.

In this application, terms related to spatial orientation, such as front, rear, above, below, left, and right, refer to the orientation that a driver sitting in a normal seating position in a vehicle would normally understand.

Various embodiments of this technology include at least one of the above objectives and/or aspects, but not necessarily all of them. It should be understood that while some aspects of this technology are proposed to address shortcomings in the prior art, they may not fully satisfy this objective, or may satisfy other objectives not specifically listed herein.

Other and/or alternative features, aspects, and advantages of this technical embodiment will become apparent from the following description, drawings, and appended claims.

To better understand this technology and its other aspects and further features, please refer to the following description, which should be used in conjunction with the accompanying drawings. The embodiments described with reference to the drawings are exemplary and are only used to explain the present disclosure, and should not be construed as limiting the present disclosure.

The embodiments of the present disclosure will now be described.

Referring to FIG. 1, a fuel pump assembly includes a pressure regulator 2. The pressure regulator 2 is located within a flange 20, with a pressure valve cover 3 below it. A portion of the fuel in the fuel delivery line is returned to the fuel reservoir 13 via a corrugated hose 5. The function of the pressure regulator 2 is as follows: when fuel is delivered to the pressure valve cover 3 and the pressure regulator 2 through the corrugated hose 5, the pressure regulator 2 senses the actual fuel pressure within the corrugated hose 5; when the pressure regulator 2 detects that the pressure within the corrugated hose 5 exceeds a set threshold, it releases the excess fuel through an internal adjustment mechanism. The following is an explanation of the internal adjustment mechanism of the pressure regulator 2: the pressure regulator 2 has a return valve inside; when the pressure is too high, the return valve opens, guiding the excess fuel back to the fuel tank or the inlet of the pump core 11. This prevents excessive fuel pressure, thereby protecting the pump core 11 and the injector. When the engine load increases, leading to an increase in fuel demand, the pressure regulator 2 appropriately adjusts the opening of the return valve to ensure that the fuel supply pressure meets the engine's needs.

The flange 20 is fixed by a structure of pin 19 and retaining ring 1. At the same time, a torsion spring 17 is provided outside the pin 19 to ensure that the fuel pump assembly does not loosen and the flange is fixed stably while ensuring the maximum swing angle. The pressure regulator 2, with or without a return-flow ESD module, is connected to the retaining ring 4 and is grounded through a brass flexible hose to eliminate the charge in the assembly. The pressure regulator 2 has a pressure valve cover below it, the pressure valve cover is connected to the corrugated hose 5.

The connection design of torsion spring 17 employed in the present disclosure possesses significant technical advantages, particularly in its superior performance in shock absorption, impact resistance, and adaptation to complex movements. The torsion spring 17 efficiently absorbs and mitigates vibrations and impacts generated during vehicle operation, preventing these forces from directly acting on critical components of the fuel pump assembly, thereby effectively extending the equipment's service life. Its elastic properties allow the torsion spring 17 to automatically adjust the relative positions of the connecting components under complex operating conditions, flexibly adapting to multi-directional movements within the fuel tank, further enhancing the stability and reliability of the fuel pump assembly. This design provides strong assurance for the smooth operation of vehicles in complex terrains or extreme environments.

The fuel delivery pipes within the fuel pump assembly all feature a corrugated hose structure design (‘corrugated hose’ refers to a flexible hose used to connect various components, providing shock absorption, impact resistance, and displacement compensation). The corrugated hose design effectively absorbs and compensates for axial, radial, and angular displacements in the piping system, thereby preventing equipment damage or pipe leaks caused by displacement. It also effectively mitigates mechanical vibration and impact, reducing vibration transmission within the fuel pump assembly. This helps reduce operating noise, extend equipment life, and improve the overall stability and reliability of the system. Furthermore, the corrugated hose design provides excellent sealing performance, effectively preventing fuel leakage while forming a tight seal at joints to prevent media leakage through interfaces, making it particularly suitable for sealing requirements in high-pressure or high-temperature environments. Its flexibility allows for easy adaptation to various layouts and joint positions within the piping system during installation. The corrugated hose is designed to withstand repeated bending and expansion, and its materials and structure can withstand multiple cyclic loads, exhibiting good fatigue resistance.

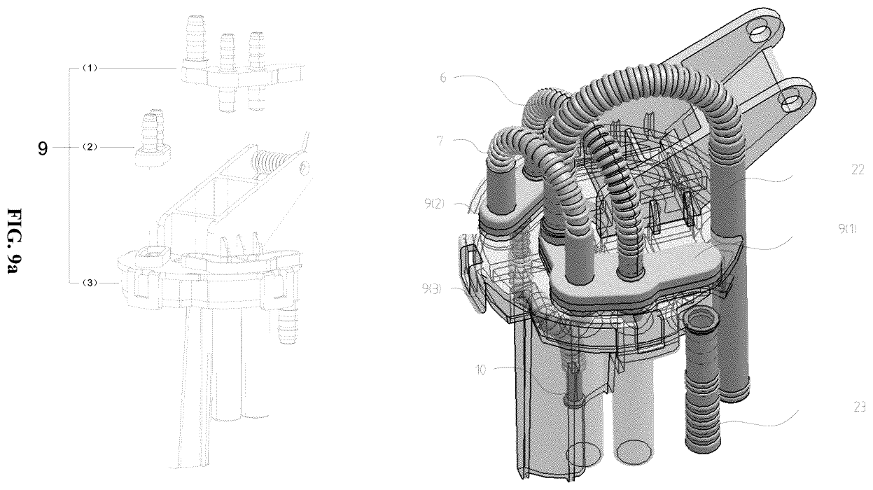

The ejector pump assembly 9 passes below the corrugated hose 5, the ejector pump assembly 9 includes a nozzle (2), a three-way connector (3), and a top cover (1). The top cover (1) enhances the stability of the assembly. The three-way connector (3) enables simultaneous flow diversion when fuel is pumped out of the pump core in the fuel reservoir 13. The nozzle (2) ejects the pumped fuel to the outlet conduit and further increases the pressure during fuel transport. The ports are opposite in direction. When the fuel level in the tank shifts, i.e., the fuel in the tank is not exhausted, at least one end of the front suction pipe 22 or at least one rear suction pipe 23 is always inserted below the fuel level to ensure fuel supply. Furthermore, the suction pipes can be divided into a front suction pipe 22 and a rear suction pipe 23. When the vehicle is on a slope for a long time, at least one end of the front suction pipe 22 or the rear suction pipe 23 of the fuel pump assembly is always below the liquid level to ensure that the fuel pump can continuously draw fuel from the tank until the fuel in the tank is exhausted, thereby improving the driving stability of the vehicle on the slope. Meanwhile, the design of the front suction pipe 22 and rear suction pipe 23 of the fuel pump assembly effectively avoids the problem of dead angles in the front suction pipe 22 or rear suction pipe 23 caused by irregular fuel tank structure, thus enabling the fuel pump 1 to fully and continuously draw fuel from the fuel tank when there is fuel in the tank. Furthermore, as shown in FIG. 8, when the fuel in the fuel pump assembly is transported from the pump core 11 to the fuel reservoir 13, the fuel path in the ejector pump is as shown in FIG. 8, at the same time that the pump core 11 outputs fuel to the ejector pump, the output of fuel from the ejector pump creates a certain negative pressure in the space inside the ejector pump, thereby driving the suction pipe connected to the ejector pump to draw fuel from the fuel tank, thus ensuring that when there is fuel in the fuel tank, there is also fuel in the fuel reservoir 13 to supply fuel to the pump core 11 to deliver fuel to the engine to maintain the continuous operation of the sled motorcycle.

Below the ejector pump assembly 9 is a pump core 11, and below the pump core 11 is an umbrella valve 12. The umbrella valve 12 is connected to the fuel tank 13 to allow fuel in the fuel tank to enter the fuel tank. The fuel pump assembly also includes at least one front suction pipe 22 and at least one rear suction pipe 23. Each end of the front suction pipe 22 and the rear suction pipe 23 is provided with a coarse filter pipe 21 to effectively ensure the cleanliness of the fuel inside the fuel pump assembly and prevent impurities from entering the fuel pump assembly and affecting its operation. The other end of the front suction pipe 22 and the rear suction pipe 23 is inserted into the top cover (1) and forms a communication structure with the corrugated hose 6 and the corrugated hose 7. The front suction pipe 22 and the rear suction pipe 23 are distributed at the front and rear ends of the entire fuel pump. The number of suction pipes is preferably two. The suction pipes are bidirectionally arranged at the end in contact with the fuel surface to ensure that one end can always be inserted below the fuel level in the fuel tank, so as to ensure that there is no dry suction due to changes in the position of the fuel tank when there is fuel in the fuel tank.

Furthermore, a fuel level assembly 14 and a resistor cord/plug (15) are provided on the outside of the fuel reservoir 13. The fuel level assembly 14 is responsible for detecting the fuel level information and outputting the fuel level information to other devices connected to the external plug through the circuit.

Furthermore, the ejector pump assembly 9 includes a nozzle (2), a three-way connector (3) and a top cover (1). The top cover (1) is connected to the nozzle (2) through a corrugated hose 6 and a corrugated hose 7. The ejector pump assembly 9 is connected to the pump core 11 below.

Furthermore, a power cord 8 is also provided, with one end connected to a clip ring 4 and the other end connected to the fuel level assembly 14. The clip ring 4 provided here can effectively prevent the power cord 8 from becoming loose.

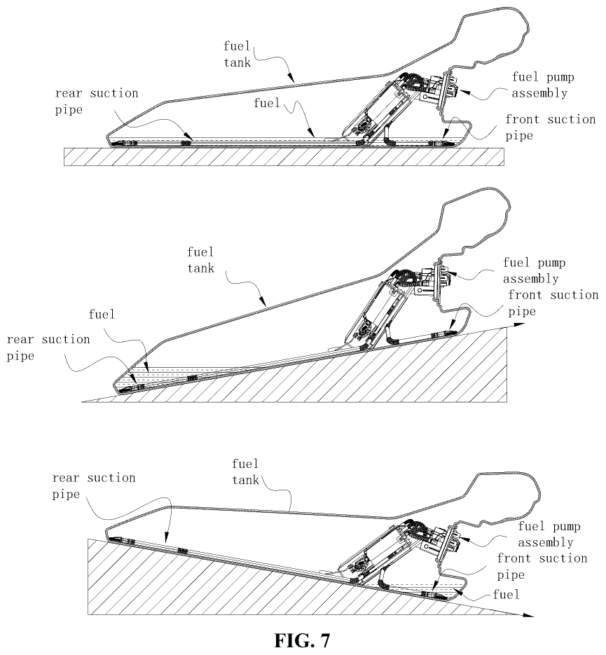

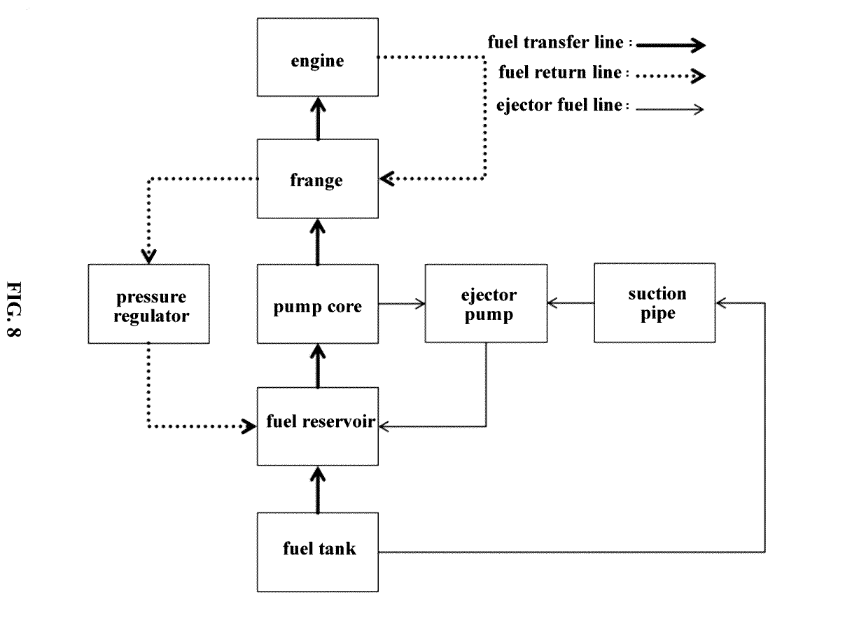

Furthermore, as shown in FIG. 7, the front suction pipe of the fuel pump assembly abuts against the bottom of the front end of the fuel tank, and the rear suction pipe abuts against the bottom of the rear end of the fuel tank. With this arrangement, regardless of the fuel level shift within the tank, either the front or rear suction pipe will always have one end submerged below the fuel level, ensuring a continuous fuel supply. Simultaneously, the close contact between the front and rear suction pipes with the front and rear ends of the fuel tank effectively avoids dead zones caused by irregular tank structure or fuel tilting, thereby significantly improving the stability of fuel supply and the reliability of vehicle operation.

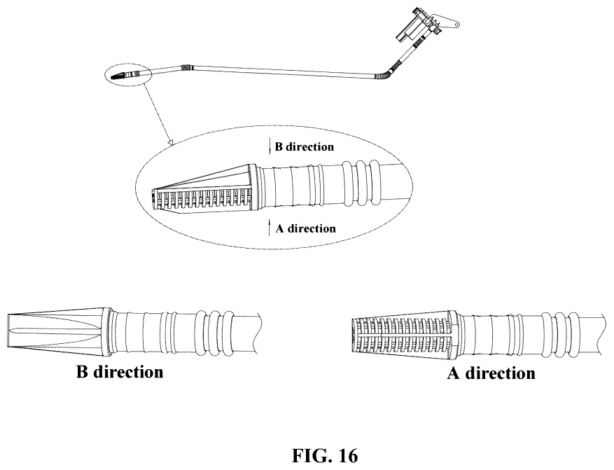

Furthermore, as shown in FIG. 16, both the front suction pipe 22 and the rear suction pipe 23 in the fuel pump assembly include a coarse filter 21 with the structure shown in the figure. The mesh design of the coarse filter structure at the end of the front suction pipe 22 and the rear suction pipe 23 can not only effectively block impurities from entering the fuel pump assembly, but also continue to draw fuel from the fuel tank when the fuel level is lower than the center line of the suction pipe, thereby significantly improving fuel utilization efficiency.

The fuel tank mentioned in this application is foot-shaped with a flat bottom. The ends of the front suction pipe 22 and the rear suction pipe 23 are distributed at the front and rear ends of the fuel tank. This fuel tank (arrangement of front and rear suction pipes) solves the problem of dead angles in the front suction pipe 22 and the rear suction pipe 23, so that the pump core can fully and continuously draw fuel from the fuel tank when there is fuel in the fuel tank.

The fuel pump assembly of the present disclosure can operate stably and continuously within a fuel temperature range of −40° C. to 40° C. and an ambient air temperature range of −40° C. to 60° C., and can be stored in environments ranging from −40° C. to 85° C. Its careful selection of materials and design ensures excellent sealing performance and reliable fuel supply under extreme temperature conditions. Furthermore, this fuel pump assembly can operate normally at altitudes ranging from 0 to 4000 meters.

The fuel pump assembly of the present disclosure is not limited to the specific structure and layout of the embodiments described, and can be designed in various variations according to actual needs. For example, the number of fuel suction pipes can be appropriately increased or decreased according to the shape of the fuel tank and the vehicle's operating conditions to adapt to complex fuel tank structures or extreme driving environments. The end of the suction pipe can be a flexible hose or a shape-memory tube to further improve its adaptability to the bottom of the fuel tank.

The present disclosure can also be applied to the fuel supply systems of other fuel-powered devices, such as off-road motorcycles, all-terrain vehicles (ATVs), or other fuel-powered devices that need to operate under complex conditions, thus expanding its applicability.

Although embodiments of the present disclosure have been shown and described, these specific embodiments are merely explanations of the present disclosure and are not intended to limit it. The specific features, structures, materials, or characteristics described may be combined in any suitable manner in one or more embodiments or examples. After reading this specification, those skilled in the art may make modifications, substitutions, and variations to the embodiments as needed without departing from the principles and spirit of the present disclosure, but such modifications, substitutions, and variations are protected by patent law as long as they are within the scope of the claims of the present disclosure.

What is claimed is:

1. A fuel pump assembly, comprising a flange, a pressure regulator, an ejector pump assembly, a pump core, a coarse filter, a fuel reservoir, a level sensor, several corrugated hoses, and suction pipes, wherein the pump core, the ejector pump assembly, and the flange sequentially form a fuel passage from the pump core to the flange; the pump core has two outlet conduits, one of which is connected to the flange via the corrugated hose to deliver fuel to an engine, and the other of which is connected to the ejector pump assembly via the corrugated hose to deliver fuel from a fuel tank to the fuel reservoir; the pressure regulator is provided in the flange, and when the pressure in the fuel passage is too high, the fuel flows into the fuel reservoir through the pressure regulator; the ejector pump assembly has at least two suction pipes, one at the front and one at the rear, with a coarse filter pipe at the end of each suction pipe; the ends of the suction pipes are respectively located at the bottoms of the front and rear ends of the fuel tank.

2. The fuel pump assembly according to claim 1, further comprising the ejector pump assembly connected to the pump core via the corrugated hose; the ejector pump assembly has at least two fuel inlets and at least two fuel outlets, the fuel outlets being located within the fuel reservoir; at least two suction pipes are installed on a fuel suction port.

3. The fuel pump assembly according to claim 2, wherein the two suction pipes are arranged in a front-to-back direction, with their ends contacting the bottoms of the front and rear ends of the fuel tank; the front suction pipe is shorter than the rear suction pipe.

4. The fuel pump assembly according to claim 3, wherein the rear suction pipe is a formed pipe, the end of which is designed to be bent downwards.

5. The fuel pump assembly according to claim 3, wherein the front and rear fuel suction pipes are each provided with a coarse filter pipe at their ends.

6. The fuel pump assembly according to claim 1, wherein the ejector pump assembly is connected to the flange via a torsion spring.

7. The fuel pump assembly according to claim 1, wherein the front suction pipe abuts against the bottom of the front end of the fuel tank and the rear suction pipe abuts against the bottom of the rear end of the fuel tank, thereby ensuring that when the fuel level in the fuel tank shifts, at least one of the ends of the front suction pipe or the rear suction pipe of the fuel pump assembly is always below the fuel level, thus ensuring a continuous fuel supply.

8. The fuel pump assembly according to claim 1, wherein a nozzle element in the ejector pump assembly has a diameter of 0.3 mm to 1.0 mm and is made of brass to adapt to different fuel viscosities and operating environments.

9. The fuel pump assembly according to claim 1, wherein the coarse filter pipe at the end of the suction pipe adopts a mesh structure design, which can not only effectively block impurities from entering the fuel pump assembly, but also continue to draw fuel from the fuel tank when the fuel level is lower than a center line of the suction pipe, thereby significantly improving fuel utilization efficiency.
